(19) United States
(12) Patent Application Publication
(10) Pub. No.: US 2008/0178500 A1
(43) Pub. Date: Jul. 31, 2008

(54) Daily calendar

(75) Inventor: Matthew H. Teuteberg, Oconomowoc, WI (US)

Correspondence Address: FOLEY & LARDNER LLP, 777 EAST WISCONSIN AVENUE, MILWAUKEE, WI, 53202-5306, US

(73) Assignee: Teuteberg Incorporated

(21) Appl. No.: 11/657,840

(22) Filed: Jan. 25, 2007

(51) Int. Cl. G09D 3/04

(52) U.S. Cl. 40/121

(57) ABSTRACT

A daily calendar with customer-provided photographs on each calendar sheet and a method of providing a daily calendar with customer-provided photographs on each calendar sheet is disclosed herein. The daily calendar includes a plurality of calendar sheets for specific period. A different photograph is printed on a front surface of each calendar sheet. The photographs are provided to the calendar manufacturer by the customer. The method includes the steps of receiving a plurality of photographs from a customer, receiving instructions from the customer for a start day of the daily calendar, assigning one photograph from the plurality of photographs to each calendar sheet, reassigning an already assigned photograph to a second calendar sheet if the plurality of calendar sheets is less than the number of calendar sheets, printing the daily calendar with the photographs from the customer, and delivering the daily calendar to the customer.

### BACKGROUND

The present description relates generally to a calendar having a separate calendar sheet for each day within a specific period (i.e., a daily calendar), and a method of providing such a calendar to a customer. More particularly, the present description relates to a daily calendar that includes one or more images (e.g., photographs, etc.) printed on each separate calendar sheet and a method of allowing the customer to personalize or customize a daily calendar by providing and/or selecting the images that are to be printed on the separate calendar sheets of the daily calendar.

Calendars are useful tools used daily by a large number of people for various reasons such as, but not limited to, determining the present date, recording an upcoming event (e.g., meeting, appointment, birthday, anniversary, party, etc.) for future reference, providing a medium for making notes. Various types of calendars exist (e.g., monthly calendars, weekly calendars, etc.). One type of calendar is a daily calendar, sometimes referred to a desk calendar or a box calendar, which generally includes a separate calendar sheet or page (e.g., sheet of paper, etc.) whereby each calendar sheet represents an individual day of a year. Daily calendars will often combine certain days on the same calendar sheet, and therefore, often include less than 365 calendar sheets. For example, it is know to combine Saturdays and Sundays on the same calendar sheet thereby providing a daily calendar with approximately 313 calendar sheets.

Daily calendars, like other types of calendars, can serve an aesthetic purpose in addition to being a useful tool. For example, daily calendars often include pre-determined images (e.g., cartoons, photographs, drawings, etc.) and/or text (e.g., motivational phrases, quotes, poetry, etc.) printed on each calendar sheet along with the practical calendar information (e.g., month, day, year, month layout, week layout, etc.). These predetermined images and/or text are selected by the calendar manufacturer without any input on the part of the end user. Many calendar users would rather display personalized or otherwise customized photographs and/or text on each separate calendar sheet than view a pre-determined canned image and/or text for each particular day. Further, a larger market for daily calendars may exist if people and/or entities were able to personalize or customize their daily calendars with their own photographs or photographs that they otherwise selected.

In addition to being a useful tool for a user and capable of having aesthetic value, a daily calendar may also serve as a marketing tool by a business (e.g., travel agency, etc.) and/or a fundraising tool by a charitable organization. For example, daily calendars printed with the name of a business could be sent to clients and/or prospective clients. Daily calendars provide valuable marketing opportunities since a daily calendar is always in front of an end user and requires the end user to attend the daily calendar (e.g., tear off a calendar sheet and look at, etc.) on a somewhat regular basis (e.g., each and every day, etc.). As such, a daily calendar having the name of a business on the individual calendar sheets would heighten an end user's awareness of the business being promoted by the daily calendar. Further still, if a business was able to customize a daily calendar by selecting its own photographs to appear on each calendar sheet, these daily calendars would become an even more valuable marketing tool.

Accordingly, there is a need for a daily calendar having a customer-provided photograph on each calendar sheet and a method of providing a daily calendar having a customer-provided photograph on each calendar sheet to a customer. There is also a need for a daily calendar and a method of providing a daily calendar wherein the customer-provided photograph used for each calendar sheet is a color photograph. There is further a need for a method of allowing a customer to provide a calendar manufacturer with a sufficient number of photographs so that a different photograph can appear on each separate calendar sheet of a daily calendar (or enough so that it gives the appearance as if a different photograph is provided on each separate calendar sheet). There is further a need to allow a customer to view a sample of a daily calendar containing photographs provided by the customer before the calendar is printed in paper form. There is further a need to allow a customer to provide a calendar manufacturer with a large number of photographs that the calendar manufacturer will than use to create a daily calendar without requiring significant input from the customer. There is further a need for a daily calendar and/or a method of providing a daily calendar addressing these and/or any other needs.

### SUMMARY

One exemplary embodiment relates to a method of providing a daily calendar with customer-selected photograph on each calendar sheet. The method includes the steps of receiving a plurality of photographs from a customer, receiving instructions from the customer, printing the daily calendar with the photographs from the customer using the instructions received from the customer, and delivering the daily calendar to the customer. The instructions received from the customer includes instructions for a format for the calendar sheet, a designated start day for the daily calendar and assignment of the photographs to a particular a calendar sheet.

Another exemplary embodiment relates to a method of providing a daily calendar with customer-provided photographs on each calendar sheet. The method includes the steps of receiving a plurality of photographs in a digital format from a customer, receiving instructions from the customer for a designated start day, assigning one photograph from the plurality of photographs to each calendar sheet, reassigning an already assigned photograph to a second calendar sheet if the plurality of calendar sheets is less than the number of calendar sheets, printing the daily calendar with the photographs from the customer, and delivering the daily calendar to the customer.

Another exemplary embodiment relates to a daily calendar personalized by a customer and produced on a commercial scale by a calendar manufacturer. The daily calendar includes a separate calendar sheet for a specific day. Each calendar sheet has a front surface. The daily calendar further includes a different photograph printed on the front surface of each calendar sheet. The photographs printed on the front surfaces of the calendar sheets are provided to the calendar manufacturer by the customer.

### BRIEF DESCRIPTION OF THE DRAWINGS

FIG. 1 is a front perspective view of a daily calendar according to an exemplary embodiment.

FIG. 2 is a front elevation view of the daily calendar of the FIG. 1, showing a customer-selected photograph on a front surface of the daily calendar.

FIG. 3 is a rear perspective view of the daily calendar of FIG. 1, showing a calendar holder according to an exemplary embodiment.

FIG. 4 is a rear elevation view of an individual calendar sheet from the daily calendar of FIG. 1 according to an exemplary embodiment.

FIG. 5 is a schematic diagram illustrating a system for providing the daily calendar of FIG. 1 according to an exemplary embodiment.

FIG. 6 is a flow chart illustrating a method of providing the daily calendar of FIG. 1 to a customer according to an exemplary embodiment.

FIG. 7 is a flow chart illustrating a method of providing the daily calendar of FIG. 1 to a customer according to another exemplary embodiment.

FIG. 8 is a flow chart illustrating a method of printing the daily calendar of FIG. 1 according to an exemplary embodiment.

### DETAILED DESCRIPTION

Referring generally to the FIGURES, a personalized or otherwise customized daily calendar 10 and a method of providing daily calendar 10 to a customer is shown according to exemplary embodiments. Generally, daily calendar 10 includes a series of pages (e.g., sheets, cards, etc.), referred to broadly herein as calendar sheets, combined to form a pad. The pad includes a sufficient number of calendar sheets for a specific period. For example, the pad may include a sufficient number of calendar sheets for each day of a year (e.g., 365 calendar sheets if a separate calendar sheet is provided for each day, 313 calendar sheets if Saturdays and Sundays are combined on the same calendar sheet, etc.). Daily calendar 10 is configured so that on a regular basis (e.g., daily, etc.) a user manipulates (e.g., moves, removes, etc.) a calendar sheet on the pad to display the calendar sheet for the next day or combination of days. Provided on a front surface of each calendar sheet 12, in addition to typical calendar information (e.g., month, day, and/or year, etc.), is at least one photograph (e.g., a colored photograph, etc.) that has been provided to a manufacturer of the daily calendar by the customer.

As such, daily calendar 10 is calendar product that allows a customer (e.g., end user, family member, business, etc.) to selectively pick the photograph that will appear on each and every calendar sheet of the calendar. According to various exemplary embodiments, such a customized or personalized calendar product may be used to display a number of relatively unrelated photographs selected by the customer for inclusion in the calendar (e.g., family pictures, company pictures, etc.), or alternatively, may be used to display a large number of related photographs taken from an event (e.g., corporate retreat, convention, vacation, etc.) or having a common theme (e.g., travel pictures for use in the promotion of a travel agency, animal pictures for use in the promotion of a veterinary clinic, etc.). According to one nonexclusive exemplary embodiment, daily calendar 10 may be customized to include photographs taken during a significant family event, such as a wedding.

It should be noted that while daily calendar 10, and a method of providing daily calendar 10, may be illustrated and/or described with reference to a daily calendar configured to display photographs taken from a weddings, daily calendar 10, and the method of providing daily calendar 10, may be used for displaying photographs relating to any of a number of subject matters.

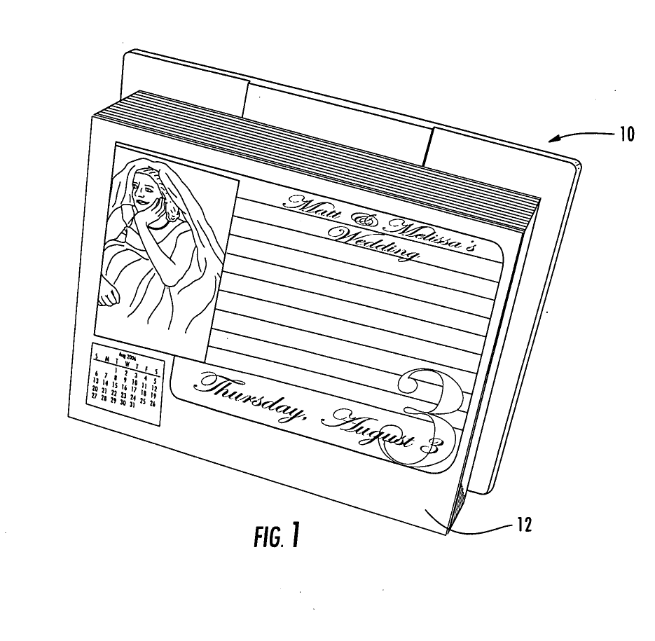

Referring now to FIG. 1, daily calendar 10 is shown according to an exemplary embodiment. Daily calendar 10 is shown as including a series of calendar sheets 12 for a specific period. Daily calendar 10 may include an individual or separate calendar sheet 12 for every day of the year, or almost every day of the year. According to an exemplary embodiment, daily calendar 10 includes approximately 313 calendar sheets 12. In such an embodiment, Saturdays and Sundays are combined on the same calendar sheet. According to the various alternative embodiments, daily calendar 10 may include a number of calendar sheets 12 greater than or less than approximately 313. For example, daily calendar 10 may start in the middle of a year and may be configured to be exhausted of calendar sheets 12 at the end of that year. Alternatively, daily calendar 10 may be configured to last for more than one year (e.g., a two-year daily calendar, etc.).

Each calendar sheet 12 is shown as being generally rectangular in shape and defined by a first edge, shown as a top edge 14, a second edge, shown as a bottom edge 16, a third edge, shown as a left edge 18, and a fourth edge, shown as a right edge 20. According to an exemplary embodiment, each calendar sheet 12 has a width that is between approximately five inches and approximately six inches and a height that is between approximately four inches and approximately five inches. For example, each calendar sheet 12 may have a width that is approximately five and a half inches and a height that is approximately four and a quarter inches. According to the various alternative embodiments, each calendar sheet 12 may have any of a number of sizes and/or shapes (e.g., circular, triangular, in the shape of an object, etc.).

Calendar sheets 12 can be made from a variety of materials including, but not limited to, paper, cardstock, cardboard, plastic or any other material that may be suitable for calendar sheets 12. According to an exemplary embodiment, calendar sheets 12 are formed of paper.

Calendar sheets 12 are coupled together to form a pad 22. It should be noted that for purposes of this disclosure, the term “coupled” is used broadly to mean the joining or combining of two or more members (e.g., calendar sheets, components, materials, etc.) directly or indirectly to one another. Such joining or combining may be relatively stationary (e.g., fixed, etc.) in nature or movable (e.g., reconfigurable, etc.) in nature. Such joining or combining may be achieved with two members or two members and any additional intermediate members being integrally formed as a single unitary body with one another (e.g., one-piece, etc.) or with the two members or the two members and any additional intermediate members being attached to one another. Such joining or combining may be intended to be relatively permanent in nature or alternatively may be intended to be relatively detachable or removable in nature.

According to an exemplary embodiment, calendar sheets 12 are coupled together along top edges 14 using an adhesive that binds calendar sheets 12 together. A relatively rigid member (e.g., a backing, etc.) may be provided after the last calendar sheet 12 to provide support for pad 22. Such a rigid member may be formed of cardboard or any other suitable backing material and may be coupled to pad 22 using the same technique coupling together calendar sheets 12.

As stated above, daily calendar 10 is configured so that on a regular basis (e.g., a daily basis, etc.) a user manipulates the exposed calendar sheet 12 to display another calendar sheet 12 for the next day or combination of days. According to an exemplary embodiment, daily calendar 10 is configured so that a user must remove (e.g., tear off, etc.) calendar sheets 12. A demarcation or perforated line may run laterally across each calendar sheet 12 to assist a user in removing calendar sheet 12 from pad 22. According to the embodiment illustrated, the bond securing calendar sheets 12 together is of such a nature that a user can readily remove the entire calendar sheet 12 without a perforated line. According to the various alternative embodiments, daily calendar 10 may be configured so that on a regular basis, a user simply moves (e.g., flips, etc.) calendar sheet 12 rather than removing the sheet.

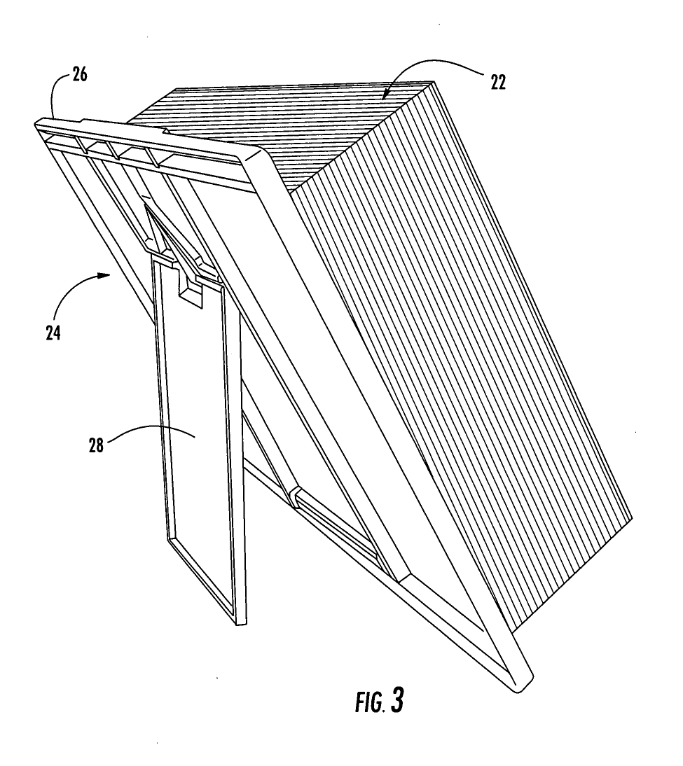

Referring to FIG. 3, pad 22 is configured to be supported in a substantially upright position (e.g., vertical, etc.) by a device (e.g., stand, frame, hanger, bracket, binding, etc.), shown as an easel 24. Easel 24 includes a base portion 26 configured to support pad 22 and a movable portion 28 (e.g., “kick stand,” etc.) coupled to base portion 26. Movable portion 28 is configured to be selectively moved by a user between a first or stowed position (not shown), wherein the movable portion 28 is substantially parallel to and flush with base portion 26, and a second or display position, wherein movable portion 28 outwardly extends at an angle relative to base portion 26. According to an exemplary embodiment, easel 24 is formed of plastic, with movable portion 28 being integrally formed with base portion 26. According to the various exemplary embodiments, easel 24 may be formed of any suitable material (e.g., paper, metal, wood, etc.). Further still, easel 24 may be replaced with any structure suitable for supporting pad 22 or removed entirely if undesirable.

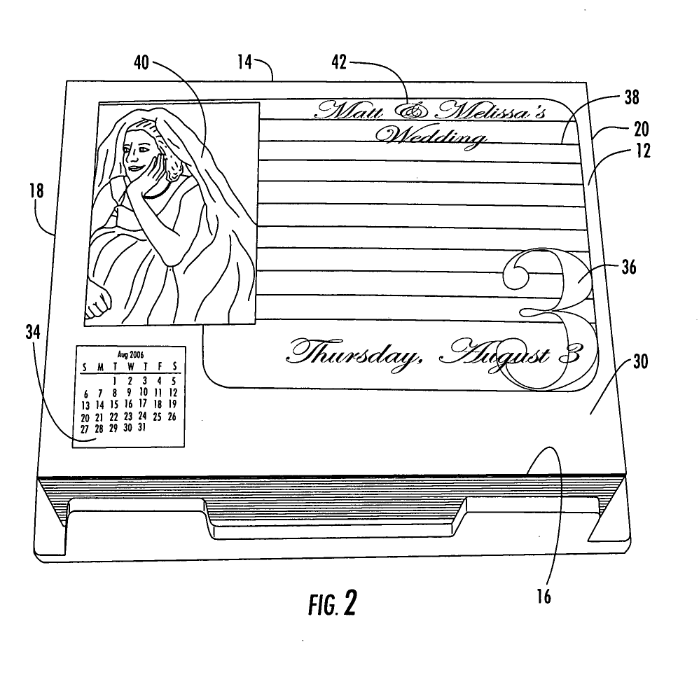

Referring back to FIG. 2, calendar sheets 12 further include a first surface, shown as a front surface 30, and a second surface, shown in FIG. 4 as a rear surface 32. Front surface 30 generally constitutes the surface that is visible to a user during normal use of daily calendar 10, while rear surface 32 constitutes the surface that is only visible to a user after calendar sheet 12 has been removed from pad 22 or otherwise moved relative to pad 22. Referring to FIG. 2 in particular, front surface 30 is shown as including a first calendar indicia 34, a second calendar indicia 36, a plurality of horizontal lines 38 stacked in a vertical direction, a photograph 40 and a title 42 relating to photograph 40. According to an exemplary embodiment, first calendar indicia 34, second calendar indicia 36, lines 38, photograph 40 and title 42 are applied to front surface 30 through a printing procedure. For example, first calendar indicia 34, second calendar indicia 36, lines 38, photograph 40 and title 42 may be printed onto front surface 30 through a variable data printing technique using digital printers as detailed below with reference to FIG. 8.

First calendar indicia 34 and second calendar indicia 36 provide a user with useful calendar information. According to the embodiment illustrated, first calendar indicia 34 is a visual representation of the current month and is provided in a lower left-hand side of front surface 30, while second calendar indicia 36 includes text reciting the present day (or combination of days) and date of the week and is provided in a lower right-hand side of front surface. Lines 38 provide an area on front surface 30 where a user may write down notes, important dates, appointments, meetings, or the like. According to the various alternative embodiments, any of a number of combinations of first calendar indicia 34, second calendar indicia 36 and lines 38 may be used. Further, the calendar indicia may be provided in other forms (e.g., weekly views, an hourly breakdown for each day, etc.) depending on needs of a target user.

Referring further to FIG. 2, photograph 40 is shown as being provided in an upper left-hand side of front surface 30. According to the various alternative embodiments, photograph 40 may be located anywhere on front surface 30 and may occupy any percentage of front surface 30. Photograph 40 is preferably a colored photograph, but alternatively may be provided in any other suitable finish (e.g., black and white, etc.). Photograph 40 is not a canned or predetermined photograph provided by a manufacturer of daily calendar 10, but rather is a photograph that has been provided to the manufacturer of daily calendar 10 by a customer of daily calendar 10. As such, daily calendar 10 becomes a personalized or customized daily calendar for the customer.

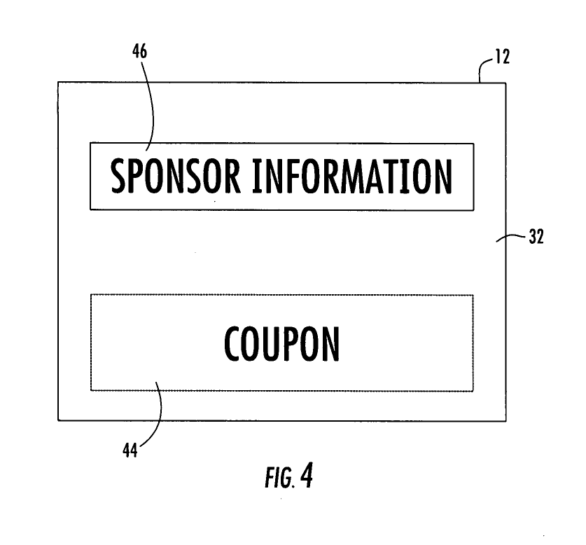

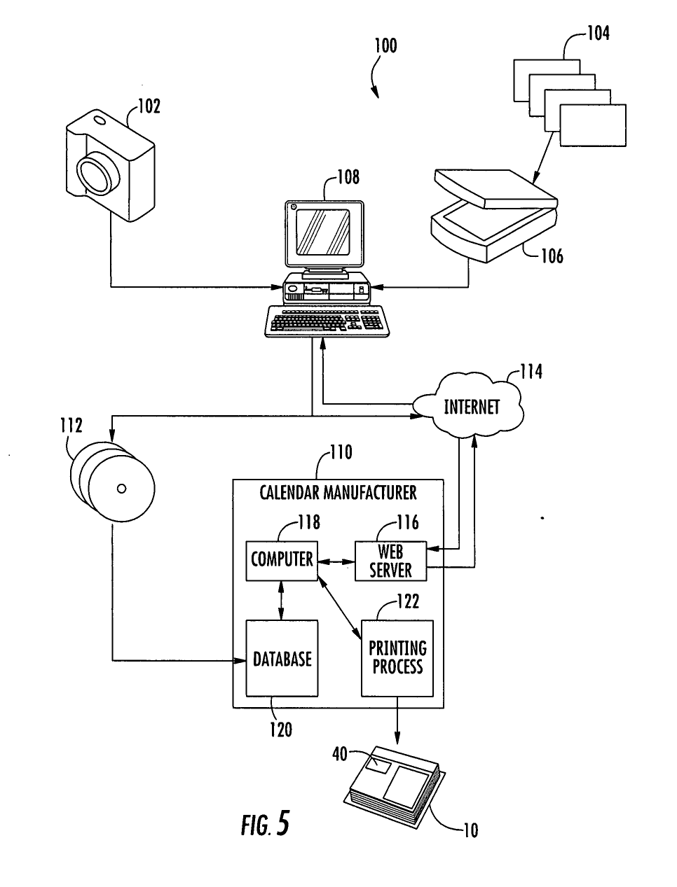

To create photograph 40, a customer provides the calendar manufacturer with one or more photographs. According to an exemplary embodiment, the customer provides the manufacturer with enough photographs so that each calendar sheet 12 includes a different photograph 40. The customer may instruct the calendar manufacturer as to what photograph should be used with each calendar sheet 12, or alternatively, may leave it to the calendar manufacturer to select the order that the photographs will appear in daily calendar 10. If fewer photographs are given to the calendar manufacturer than the number of calendar sheets 12, the calendar manufacturer simply reuses a photograph used previously. The method of providing the photographs and manufacturing daily calendar 10 with photographs 40 is detailed below with reference to FIGS. 5 through 7.

The subject matter of photograph 40 is controlled by the customer. For example, the customer may provide the calendar manufacturer with a plurality of photographs from a significant family event, such as a wedding. A daily calendar 10 filled with photographs from an event will allow the customer to memorialize the event and/or to share the memories of the event with others by distributing the customized daily calendars 10 to friends and/or relatives. Alternatively, a business may provide the calendar manufacturer with a plurality of photographs relating to its business. These daily calendars can than be sent to clients of the business and/or prospective clients as a marketing tool for the business.

One nonexclusive example of a business that may find daily calendar 10 desirable for its marketing efforts is a professional sports team. Such a business can provide the calendar manufacturer with a number of photographs relating to the team and/or the particular sport. Rather than creating a calendar for an entire year, the business may request that daily calendar 10 only includes calendar sheets 12 for the particular sport's season (e.g., April through October for baseball, etc.). The business can then provide these customized daily calendars 10 to season ticket holders or prospective ticket holders in an effort to generate interest about the team. In addition to photographs 40, such daily calendars 10 may include text on the appropriate calendar sheets 12 indicating the time of the game and the opponent. According to the various alternative embodiments, any type of business may utilize a customized daily calendar 10 as a marketing tool.

Referring again to FIG. 2, title 42 is shown as being provided at an upper right-hand side of front surface 30. Title 42 relates to photograph 40 and has been provided to the calendar manufacturer by the customer. According to the various alternative embodiments, photograph 40 may be located anywhere on front surface 30 and may occupy any percentage of front surface 30. In addition to title 42, front surface 30 may also include additional text that has been selected by a customer. Such additional text may appear on every calendar sheet 12, or alternatively, may be limited to one or more calendar sheets 12. For example, a customer may instruct the calendar manufacturer to add birthday information for various people or other significant information on the appropriate days of the year.

Referring to FIG. 4, back surface 32 of calendar sheet 12 is shown according to an exemplary embodiment. As stated above, back surface 32 is typically not visible to the user until calendar sheet 12 is removed from pad 22. Back surface 32 may be left blank, or alternatively may include additional images and/or text. According to the embodiment illustrated, back surface 32 is shown as including a coupon 44 (e.g., sales promotion materials, etc.) and sponsor information 46 (e.g., company name, logo, etc.). Both coupon 44 and sponsor information 46 are printed on back surface 32. For such an embodiment, calendar sheet 12 is formed of a material that substantially sufficient to prevent coupon 44 and sponsor information 46 from being visible from front surface 32 when calendar sheet 12 is still attached to pad 22.

Referring to FIG. 5, a system 100 for providing receiving photographs from a customer and for manufacturing a daily calendar with the photographs received from the customer is shown according to an exemplary embodiment. In system 100, photographs to be used in daily calendar 10 as photographs 40 are delivered from a customer to a calendar manufacturer 110. Such photographs may be delivered in any of a variety of ways and in any of a variety of formats. According to one exemplary embodiment, photographs are delivered to manufacturer 110 as digital images. For example, digital images may be produced from a digital camera 102, or alternatively, from the scanning of actual prints 104 using a scanning device 106. The customer will typically have a computer 108 (or access to a computer 108) to which the digital images can be received from digital camera 102 and/or scanning device 106.

Calendar manufacturer 110 includes a database 120 that is connected to a printing process 122 through a computer 118. Database 120 is configured to receive the digital images submitted by the customer, while computer 118 supports software configured to take the digital images and provide instructions for printing to printing process 122. According to an exemplary embodiment, calendar manufacturer 110 is capable of transferring digital images that have been submitted on a portable storage device (e.g., disk, memory card, etc.), shown as a compact disc 112, to database 120. Such capabilities may allow a customer to conveniently submit a large number of digital images to calendar manufacturer 110. According to another exemplary embodiment, calendar manufacturer 110 includes a website having a webpage that can be accessed by the customer.

To support the website and webpage, calendar manufacturer 110 includes a web server 116 that is connected to computer 118 that allows the customer to submit digital images over an online network to calendar manufacturer 110. The online network may be any network that supports the TCCP/IP protocol (such as the Internet 114 or an intranet). Web server 116 is a hardware component that includes software that receives, manages and responds to the customers request for and/or submittal of documents. 100381 According to the embodiment illustrated, the customer accesses the website of calendar manufacturer 110 over the internet 114. The customer than creates a personal account with calendar manufacturer 110 wherein the customer will be asked to submit certain personal information (e.g., name, contact information, billing information, etc.) and in return receives a password allowing the customer to access a file transfer protocol (“FTP”) site of the company. The FTP site is used to connect computer 108 of the customer to computer 118 of calendar manufacturer 110 over the internet 114 so that the customer can transfer digital image files to server 116 and/or computer 114 of calendar manufacturer 110. The digital images may be transferred in any suitable file format including, but not limited to, .pdf, .tiff, .bmp, or .jpeg. Once connected to the FTP site, the customer can do a number of file manipulation operations such as uploading files to web server 116, download files from web server 116, rename or delete files on web server 116 and so on.

It should be noted that system 100 can be implemented on any platform such as computer 118 or other suitable workstation in communication with printing process 122. According to various alternative embodiments, a customer can implement the process (at least partially) on its own computer 108 using software downloadable from the calendar manufacturer. Equipment for system 100 is shown for illustrative purposes only, as it is not discussed in a limiting fashion.

FIG. 6 is a process flow diagram illustrating a method of manufacturing daily calendar 10 for a customer according to one exemplary embodiment. This method involves a transaction between the customer and the calendar manufacturer that takes place through the website of the calendar manufacturer. In a step 132, a calendar manufacture receives digital images from the customer that will be used as photographs 40 in daily calendar 10. In a step 134, the calendar manufacturer receives instructions from the customer relating to what digital image should be assigned to each calendar sheet 12 (i.e., what digital image will form each photograph 40) or simply the desired order that the digital images will appear in daily calendar 10. In a step 136, the calendar manufacturer allows the customer to add variable text (e.g., messages, birthdays, etc.) to each calendar sheet 12 and thereby receives instructions from the customer, if desired, relating to what text should appear on each calendar sheet 12. These instructions may relate to text on front surface 30 and/or back surface 32 of calendar sheet 12.

In a step 138, the calendar manufacturer receives instructions from the customer relating to what title or heading should appear on each calendar sheet 12. In a step 140, the calendar manufacturer receives instructions relating to the format or layout of each calendar sheet 12. According to an exemplary embodiment, the calendar manufacturer may offer a number of standard formats for calendar sheet 12 that can be selected by the customer. According to the various alternative embodiments, the customer may be able to submit a customized template for calendar sheet 12.

In a step 142, the calendar manufacturer receives instructions from the customer relating to the desired start date for daily calendar 10. The start date may be any date selected by the customer and need not be the first of the year. Step 142 may also allow the customer to select a termination date for daily calendar 10 (i.e., the date at which daily calendar 10 will be exhausted of calendar sheets 12). Based on the instructions provided by the customer, daily calendar 10 may be designed to last one year, greater than one year or less than one year.

After the calendar manufacturer receives the digital images and one or more of the instructions provided by the customer in steps 132 through steps 142, the calendar manufacture uses such digital images and instructions to create an electronic sample of daily calendar 10. This electronic sample may be first proofed by the calendar manufacturer, but is ultimately made available to the customer for viewing in a step 144. Step 144 also allows the customer to edit (e.g., make changes, additions, deletions, etc.) the sample calendar. Once the customer is satisfied with the appearance of the sample calendar, the customer provides instructions to the calendar manufacturer to print daily calendar 10. Upon receiving these instructions, the calendar manufacturer prints daily calendar 10 in a step 146 using a process detailed below and shown in FIG. 8.

The above-described method may be most attractive to an individual customer who is willing to spend the time required to pick out a photograph for each calendar sheet 12 (or at least assign the order of the photographs) and create text to be added variably throughout. For example, this method may be used by the card manufacturer when working with someone who wants to create a daily calendar having photographs of his or her family. This method may also be attractive to a business and/or charitable organization that intends to use daily calendar 10 as a marketing tool. Such a customer is likely to have the personnel and/or motivation to invest the amount time required in this method.

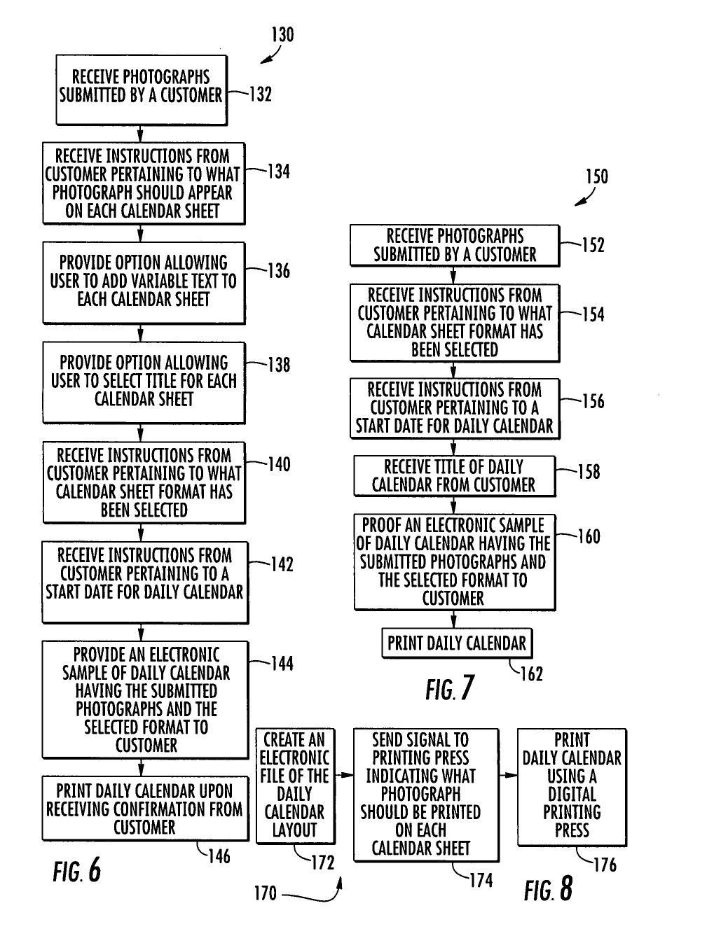

It is recognized that the method detailed above may not provide a cost and/or time efficient method that is likely to be desirable by certain customers (e.g., professional photographers, etc.). To accommodate these customers, a second method of manufacturing daily calendar 10 is provided. Referring to FIG. 7, in a step 152, a calendar manufacturer receives digital images from the customer that will be used as photographs 40 in daily calendar 10. For such an embodiment, the digital images may be delivered via the internet 114 or may be delivered by having the customer submit a data storage device (e.g., compact disc 112, etc.) with the digital images saved thereto. The sending of a data storage device with the digital images may be more efficient for some customers. For example, a professional photographer who has just taken hundreds of digital photographs at a wedding may rather submit the data storage device to which the images have been saved rather than download the images to computer 108 and then upload the images to computer 118.

In a step 154, the calendar manufacturer receives instructions relating to the format or layout of each calendar sheet 12. According to an exemplary embodiment, the calendar manufacturer may offer a number of standard formats for calendar sheet 12 that can be selected by the customer. In a step 156, the calendar manufacturer receives instructions from the customer relating to the desired start date for daily calendar 10 and/or the desired termination date. In a step 158, the calendar manufacturer receives instructions from the customer relating to what title or heading should appear on each calendar sheet 12 (e.g., the name of the couple that got married, etc.).

Unlike the method detailed above with reference to FIG. 6, this method does not have the customer selecting photographs for each calendar sheet 12. The calendar manufacturer may simply use the digital images in the order they are received from the customer to provide photographs 40, or alternatively may randomly select the order of the digital images to provide photographs 40. If an insufficient number of digital images are provided, the calendar manufacturer will reuse previously used images. If more digital images are provided than the number of calendar sheets 12, the calendar manufacturer will only use a portion of the digital images provided.

Eliminating the step of assigning individual photographs to particular calendar sheets 12 for the customer may allow the customer to offer these daily calendars to an end user at a lower price. For example, with the above method, a professional photographer hired to take photographs for a wedding may offer the daily calendars as part of a wedding photograph package at a nominal cost in comparison to the entire cost of the package. The professional photographer can simply deposit the photographs taken at the wedding with the calendar manufacturer, along with at least the name of the couple that was married, and receive a personalized daily calendar without any further effort.

It should also be noted that the information received in step 154 through step 158 can be submitted to the calendar manufacturer through the website of the calendar manufacturer or by any other means that may be more convenient to the customer. For example, the customer may simply provide the calendar manufacturer with written instructions via email or standard mail or may simply provide the instructions orally to the calendar manufacturer.

After the calendar manufacturer receives the digital images and one or more of the instructions provided by the customer in steps 154 through steps 158, the calendar manufacturer uses such digital images and instructions to create an electronic sample of daily calendar 10. This electronic sample is proofed by the calendar manufacturer in a step 160 and is then printed in a step 162 using a process detailed below and shown in FIG. 8.

Referring now to FIG. 8, a method of printing daily calendar 10 is shown according to an exemplary embodiment. In such an embodiment, daily calendar 10 is printed using a variable data printing (“VDP”) technique. Using VDP allows changes relating to photograph 40 and/or text for each calendar sheet 12 to be made on-demand without stopping or slowing down the printing press. This information is created in a step 172 using the digital images and instructions submitted by the customer and stored within database 120. In a step 174, computer 118 sends a signal to a printing press within printing process 122 representative of what should be printed on each calendar sheet 12. In a step 176, daily calendar 10 is printed using a digital printing press. One or more copies of the customized daily calendar 10 may be produced depending upon the needs of the customer.

It should be noted that the method of printing daily calendar 10 detailed above is not limited to printing daily calendar 10 using VDP. According to the various alternative embodiments, daily calendar 10 may be printed using any known or otherwise suitable printing technique including, but not limited to, an offset printing technique. For certain orders, offset printing may be more cost effective to use than VDP. For example, with the current state of printing technology, offset printing may prove to be a more cost effective printing technique over VDP for high volume orders (e.g., orders greater than approximately 10,000 daily calendars, etc.).

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. Although only a few embodiments of the present inventions have been described in detail in this disclosure, those skilled in the art who review this disclosure will readily appreciate that many modifications are possible (e.g., variations in methods of manufacturing, variations in sizes, dimensions, structures, shapes and proportions of the various elements, use of materials, colors, orientations, etc.) without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It will further be appreciated that system 100 may perform fewer or additional functions as compared to those described herein. For example, a calendar provider (e.g., manufacturer) that performs only some of the above-mentioned processes may use a computer system that contains only a subset of the functions described herein. Additionally, one or more of the systems or functions of system 100 may be variously combined in alternative configurations.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

1. A method of providing a daily calendar with a customer-selected photograph on each calendar sheet of the daily calendar, the method comprising:
receiving a plurality of photographs from a customer;
receiving instructions from the customer for a format for the calendar sheet, a designated start day for the daily calendar and assignment of the photographs to a particular calendar sheet;
printing the daily calendar with the photographs from the customer using the instructions received from the customer; and
delivering the daily calendar to the customer.

2. The method of claim 1, wherein the step of receiving a plurality of photographs from a customer includes receiving the plurality of photographs as digital images.

3. The method of claim 2, wherein the step of receiving a plurality of photographs from a customer includes receiving the digital images via a communications network.

4. The method of claim 3, wherein the step of receiving a plurality of photographs from a customer includes receiving the digital images via an internet connection.

5. The method of claim 4, further comprising the steps of:
providing a website server supporting a website; and
allowing the customer to upload photographs via the website and onto the website server.

6. The method of claim 5, wherein the step of receiving instructions from the customer includes receiving the instructions via the website.

7. The method of claim 5, further comprising the step of allowing the customer to view an electronic copy of the daily calendar via the website before the daily calendar is printed.

8. The method of claim 2, wherein the step of receiving a plurality of photographs from a customer includes receiving the digital images on a storage device.

9. The method of claim 1, wherein the step of printing the daily calendar includes printing the daily calendar using a variable date printing technique.

10. A method of providing a daily calendar with a customer-provided photograph on each calendar sheet, the method comprising:
receiving a plurality of photographs in a digital format from a customer;
receiving instructions from the customer for a designated start day;
assigning one photograph from the plurality of photographs to each calendar sheet;
reassigning an already assigned photograph to a second calendar sheet if the plurality of calendar sheets is less than the number of calendar sheets;
printing the daily calendar with the photographs from the customer; and
delivering the daily calendar to the customer.

11. The method of claim 10, wherein the step of assigning one photograph from the plurality of photographs to each calendar sheet is completed without assistance from the customer.

12. The method of claim 10, wherein the step of receiving a plurality of photographs from a customer includes receiving the photographs on a storage device.

13. The method of claim 10, further comprising the step of using the photographs received from the customer in the order that the photographs are received.

14. The method of claim 10, further comprising the steps of:
providing a website;
allowing the customer to upload the plurality of photographs via the website;
allowing the customer to proof an electronic copy of the daily calendar via the website; and
printing the daily calendar after receiving approval from the customer.

15-20. (canceled)

21. The method of claim 10, wherein the photographs relate to a common event.

22. The method of claim 10, further comprising the step of providing a separate calendar sheet for each weekday.

23. The method of claim 22, further comprising the step of providing a shared calendar sheet for each weekend.

24. The method of claim 22, further comprising the step of printing calendar information and at least one photograph on a front surface of each calendar sheet.

25. The method of claim 24, further comprising the step of printing promotional material on a back surface of each calendar sheet.

26. The method of claim 22, further comprising the step of coupling the calendar sheets together to form a pad that is configured to be supported by an easel.
